(19) United States
(12) Patent Application Publication
(10) Pub. No.: US 2004/0046783 A1
(43) Pub. Date: Mar. 11, 2004

(54) External display for communicating with a mobile terminal

(76) Inventor: Franco Montebovi, Lund (SE)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/234,515

(22) Filed: Sep. 5, 2002

(51) Int. Cl. G09G 5/00

(52) U.S. Cl. 345/730; 345/748

(57) ABSTRACT

This invention relates to an external display for communicating with a mobile terminal such as a mobile telephone, a cellular phone or a personal digital assistant. In particular, this invention relates to an external display enabling a user of a mobile terminal to utilise the external display for displaying various information. Further, this invention relates to a system and method for providing communication between an external display and a mobile terminal.

### FIELD OF INVENTION

This invention relates to an external display for communicating with a mobile terminal such as a mobile telephone, a cellular phone or a personal digital assistant. In particular, this invention relates to an external display enabling a user of a mobile terminal to utilise the external display for displaying various information. Further, this invention relates to a system and method for providing communication between an external display and a mobile terminal.

### BACKGROUND OF INVENTION

Chat boards, radios and MP3 players are well known peripherals for mobile terminals and further printers and projection units are known from calculators and different game consoles. In fact, some aeroplanes, buses or even cars have been fitted with displays on the back of seats enabling passengers during transportation to watch videos or play various games.

American patent U.S. Pat. No. 6,275,333, which hereby is incorporated in present specification by reference, discloses a cell phone peripheral comprising a removable magnification device mounted onto the display window of a cell phone. The magnifying device provides a user of the cell phone with an enlarged view of the information presented on the display window of the cell phone so that users having reduced eyesight may read the information of the display window. However, the invention disclosed presents an enlargement of information which generally is intended for the user of the cell phone only, thus the invention provides no means for projection of the information displayed in the display window to a peripheral display unit.

International patent application WO 02/05518, which hereby is incorporated in present specification by reference, discloses a cell phone incorporating an optical projector for displaying of data. The cell phone receives electronic data through a wireless network, for example, the Internet, and display the data by way of a built in projector, which projects the received data onto an external surface. However, the invention disclosed provides a single incorporated projection unit to display information received by an associated cell phone. Thus not providing means for establishing a common publicly accessible display by any mobile terminals requesting the display.

Hiring of information technology equipment such as telephones, Internet access and arcade games placed in public places e.g. trains, aeroplanes, hotel lounges, train stations, or airports is at present a well established business. However, the hiring of information technology equipment is packaged as a personal computer with Internet access or a television with a set-top box, thus the user interacts with the equipment directly either identifying themselves through identity cards or login procedures.

### SUMMARY OF THE INVENTION

An object of the present invention is to overcome the shortcomings of the prior art technologies by providing an external display communicating with a mobile terminal, identifying the mobile terminal, and enabling the mobile terminal to utilise the external display for displaying any requested information.

A further object of the invention is to provide a system and method for establishing communication between an external display and a mobile terminal.

A particular advantage of the present invention is provision of a system, a method and an external display enabling one or more mobile terminals communicating concurrently with the external display thus providing a display platform for sharing information e.g. playing a common game.

A particular feature of the present invention relates to enabling a mobile terminal access to public communication networks such as the Internet, and enabling the mobile terminal to browse on the public communication network and perform trade actions.

The above objects, advantage and feature together with numerous other objects, advantages and features, which will become evident from below detailed description, is obtained according to a first aspect of the present invention by a method for providing a communication session between a mobile terminal and an external display, comprising:

(a) receiving a request from said mobile terminal for establishing said communication session by means of said external display connecting to said mobile terminal through a first communications network; and

(b) receiving instruction data from said mobile terminal and executing said instruction data by means of said external display.

The term “a” or “an” should in this context he construed as “one”, “a single”, “at least one”, or “one or more”.

The method according to the first aspect of the present invention may further comprise the step of verifying identity of the mobile terminal by means of the external display so as to ensure the identity is valid before the receiving step.

The method according to first aspect of the present invention may further comprise displaying a standby image by means of the external display until the verifying identity determines the identified is valid. The external display may thus provide an information platform for providing persons standing by with relevant information. The external display by providing this information may in fact trigger some of these persons to initiate a communication session with the external display. The standby image may comprise a stream of images and/or audio effects such as videos or online time tables of for example departures or arrivals of aeroplanes.

The method according to first aspect of the present invention may further comprise waiting for the request from the mobile terminal by means of the external display. While presenting a standby image the external display may enter a wait state, while waiting for a mobile terminal to initiate a communication session.

The method according to first aspect of the present invention may further comprise transmitting the request to the external display by means of the mobile terminal, the request comprising an identity signal. When the mobile terminal initiates a communication session the mobile terminal transmits an identification signal so as to allow the external display to authenticate the mobile terminal prior to enabling the mobile terminal to start utilising the external display. The identity is an International Mobile Station Identifier (IMSI).

The verifying identity according to the first aspect of the present invention may comprise performing a database lookup by means of the external display communicating with a server through a second communication network, the server communicating verification data to the external display. The identity information relating to the initiating mobile terminal may be authenticated by utilising a communication network such as the Internet. In case the external display cannot authenticate the mobile terminal the method may terminate the communication session in accordance with the verification data.

On the other hand in case the external display verifies the mobile terminal identity the method according to the first aspect of the present invention may initiate a session recorder recording the communication session parameters. The communication session parameters may comprise information such as log in time, log out time, and/or data transfer amount.

The method according to the first aspect of the present invention may further comprise displaying a ready image by means of the external display so as to inform a user of the mobile terminal that the communication session has begun. The user is informed following the external display has verified the identity of the initiating mobile terminal.

Subsequently, the method may further comprise transmitting instruction data to the external display by means of the mobile terminal. That is, the mobile terminal forwards instruction data to be executed by the external display. The instruction data may comprise graphical data to be displayed on the external display, control data to be executed by the external display, or any combination thereof. The graphical data may comprise images to be presented without any processing by the external display while control data comprise instructions to be performed by the external display.

The method according to the first aspect of the present invention may further comprise billing the mobile terminal in accordance with communication session parameters by means of the external display. The billing may comprise terminating the session recorder recording the communication session parameters and calculating on the basis of the communication session parameter a debit of an account of the mobile terminal by means of the external display. In addition, the debit may be communicated to the server through the second communication network by means of the external display. Alternatively, to billing the service provided by the method according to the first aspect of the present invention may be fully or partly financed by advertisements such as pop-ups or banners.

In an alternative embodiment of the present invention the user pays beforehand either by credit card, cash or some other prepaying means. The user would then be allowed to use the service according to the amount paid, which would entitle to a certain time or amount of data to be transferred.

The communication session may be maintained until a quit instruction in the instruction data is identified by means of the external display.

The above objects, advantage and feature together with numerous other objects, advantages and features, which will become evident from below detailed description, is obtained according to a second aspect of the present invention by an external display for providing a communication session with a requesting mobile terminal, comprising:

(a) a first I/O unit for communicating with said mobile terminal through a first communications network;

(b) a second I/O unit for communicating with a server through a second communications network;

(c) a processor unit for executing instruction data received by said first I/O unit and for presenting data received by said second I/O unit; and

(d) a display unit for displaying images driven by a first driver unit and displaying images in accordance with instructions from said processor unit.

The first I/O unit according to the second aspect of the present invention may comprise a wireless connection such as an infrared connection or bluetooth connection, a wired connection such as a docket station or wired connector, or any combinations thereof for connecting to the first communication network. The connection established between the external display and the mobile terminal may in fact be constituted in any way known to persons skilled in the art.

The second I/O unit according to the second aspect of the present invention may comprise a wired or wireless connection to a dedicated line, a local area network, wide area network, metropolitan area network, internetwork, or any combinations thereof. The connection established between the external display and the service providers or servers may constitute cable, terrestrial or satellite television network, any computer networks, power line network, telephone network or any combinations thereof. The second communications network may comprise a connection to a plurality of servers presenting information such as movie streams, games, stock market views, Internet access, shopping facilities, or any combination thereof.

The processor unit according to the second aspect of the present invention may comprise a microprocessor adapted to execute instruction data received from the mobile terminal, the instruction data being graphical data for direct display on the display or control data for direct executing by the microprocessor. The microprocessor may be implemented by any type such as 8031, 8051 or the like or as a micro-controller such as 80535. Needless to say the above are illustrative examples any microprocessor or micro-controller known to the person skilled in the art may be utilised as long as the processor unit may be adapted to execute instruction data from a plurality of mobile terminals concurrently.

The display according to the second aspect of the present invention may comprise a size such as in the range from 6″ to 42″ or ranges 6″ to 12″, 10″ to 16″, 14″ to 26″, 24″ to 42″. In fact, the display may comprise a series of associated display units. The display may comprise a cathode ray tube display, liquid crystal display, a projection unit display or any combination thereof. Thus the display may utilise a wide variety of displaying techniques so as to meet any specific customer requirements.

The external display according to the second aspect of the present invention may further comprise a load speaker driven by a second driver receiving audio in accordance with the instruction data from the processor unit. Obviously, when displaying video signals the external display may be capable of providing an associate audio signal to the user of the mobile terminal.

The external display according to the second aspect of the present invention may incorporate any features of the method according to first aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1, shows a system according to a first, second, third and fourth embodiment of the present invention;

FIG. 2, shows a block diagram of the external display according to the first, second, third and fourth embodiment of the present invention; and

FIG. 3, shows a flow chart of a method according to a fifth embodiment of the present invention for communicating between an external screen and a mobile terminal.

### DETAILED DESCRIPTION OF PREFERRED EMBODIMENTS

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

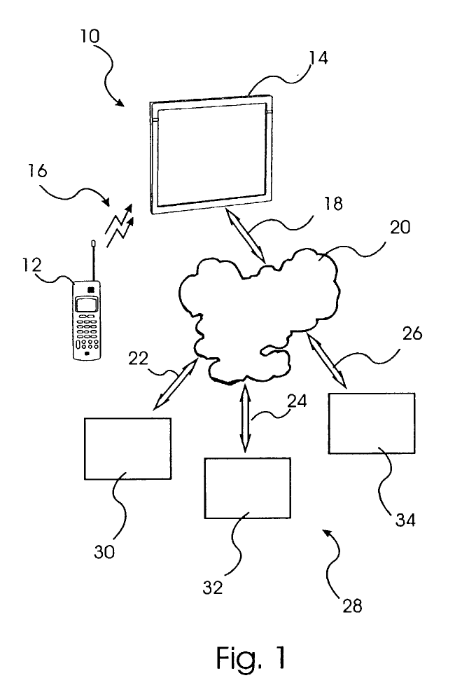

FIG. 1, shows a system according to a first embodiment of the present invention designated in entirety by reference numeral 10 and enabling a mobile terminal 12 such as a mobile telephone, cell phone, or personal digital assistant (PDA), communication with a external display 14. The mobile terminal 12 communicates with the external display 14 through a wireless communication path 16, such as bluetooth or infrared connection. However, in alternative embodiments of the present invention the mobile terminal 12 may communicate with the external display 14 through a wired connection such as a cable or through a docking station.

The external display 14 connects through a network connection to a communications network 20, such as a computer network (LAN, WAN, MAN, WLAN or the Internet), a telephone communications network (general or wireless), a television network (cable, satellite or terrestrial) or any combination thereof, so as to establish a communication with services on the communications network 20.

The communications network 20 comprises a plurality of network connections 22, 24, 26 to a plurality of servers 28 providing services for any requesting mobile terminal. The plurality of servers 28 exemplified by servers 30, 32, and 34 provide a requesting mobile terminal with services such as shopping facilities, game facilities or video facilities. However, any type of services known to a person skilled in the art will suffice.

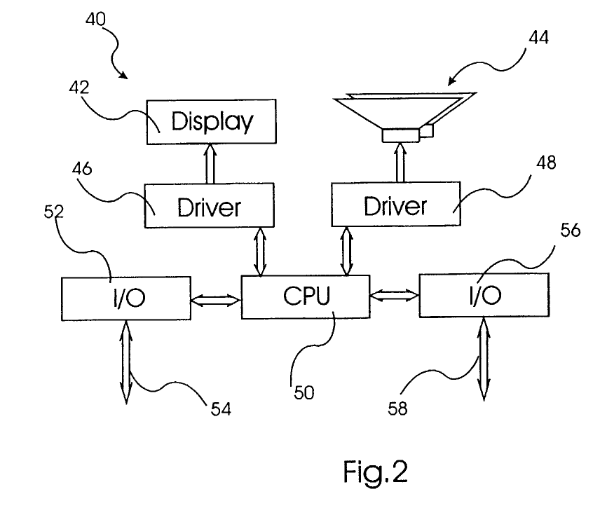

FIG. 2, shows a block diagram of the external display according to the first embodiment of the present invention, which external display is designated in entirety by reference numeral 40. The external display 40 comprises a display 42 for presenting visual information to a spectator, which could be the holder of the connecting mobile terminal.

The display 42 may have any size such as in the range from 6″ to 42″ or ranges 6″ to 12″, 10″ to 16″, 14″ to 26″, 24″ to 42″. In fact the display 42 may comprise a series of displays operating in co-operation so as to constitute even larger displays or obtain particular visual effects.

The external display 40 further comprises one or more loudspeakers 44 for presenting audio information to the spectator. The one or more loudspeakers may be constituted by headphones or ordinary loudspeakers configured in mono, stereo or surround sound.

Display 42 and the one or more loudspeakers 44 are driven by drivers 46 and 48, respectively. The drivers 46, 48 communicate information received from a central processing unit (CPU) 50. The CPU may be any type of general purpose micro processor or micro controller.

When a mobile terminal requests use of the external display 40, the CPU 50 is notified by a first I/O unit 52 receiving a request signal from the mobile terminal. The request signal may transmitted through a wire or wireless connection 54, which as described with reference to FIG. 1 may comprise wireless connections such as bluetooth or infrared and/or wired connections such as cables or docking stations.

The mobile terminal may order a streamed movie, a stock market view or an Internet connection though the connection 54. Prior to enabling the mobile terminal to access various information products the CPU 50 registers the identity of the mobile terminal for billing. The CPU 50 utilises a polling or requesting procedure to obtain the identity of the mobile terminal, which may be the International Mobile Station Identifier (IMSI). The CPU 50 processes the mobile terminal's request and connects through a second I/O unit 56 and a connection 58 to any server connected in a computer network and transmits the requested data to the display 42 and/or loud speakers 44.

The CPU 50 enables the external display 40 to communicate with mobile terminals and enables the external display to execute simple or complicated commands

The connection 56, in one particular embodiment of the present invention, may connect the CPU 50 directly to a first server accessing further servers in a computer network. In addition, a hub may interconnect the second I/O 56 and the server or servers.

The mobile terminal is billed for the services ordered based on either amount of data transferred to the external display 40 or amount of time spent hooked up to the external display 40.

The mobile terminal according to a first embodiment of the present invention communicates with the external display 40 by transmitting graphical data generated internally in the mobile terminal for the local display of the mobile terminal. Thus the required computation during a session of utilising the external display 40 is performed by the mobile terminal.

The mobile terminal according to a second embodiment of the present invention communicates with the external display 40 by transmitting control data, such as MOVE (object “A”, dX, dY) or even more complex depending on which application is run and on the computing capabilities of the external display 40. The mobile terminal acts in this way as a control device for applications run on the external display 40.

The external display 40 enables concurrent communication with a plurality of mobile terminals thereby enabling any number of mobile terminals to simultaneously communicate with the external display 40. This is particularly advantageous during multiplayer sessions in f-or instance games. The communication between the mobile terminals and the external display 40 may according to a third embodiment of the present invention be accomplished by one of the plurality of mobile terminals communicating control data to the external display 40 for the other mobile terminals. The communicating mobile terminal receives control data from the other mobile terminals through a wired and/or wireless connection e.g. bluetooth.

The communication between the mobile terminals and the external display 40 may according to a fourth embodiment of the present invention be accomplished by the external display 40 receiving control data from each of the plurality of mobile terminals, while the plurality of mobile terminals at the same time communicate with one another. The external display 40 acts as a shared memory, such as a Random Access Memory (RAM), which memory is protected restricting means for restricting access to the shared external display 40 e.g. semaphores or other synchronization means.

Alternatively, the shared memory containing data for the pixels of the external display 40, is unprotected thus allowing for the possibility of any number of mobile terminals writing to the same section of memory space at the same time at different speeds. Obviously, this may lead to distortion of the images displayed on the external display 40. The shared memory in this case may receive different information for a specific pixel from several mobile terminals.

Further alternatively, the shared memory may be protected differently for different sections of the memory space or the external display 40. For example, each mobile terminal may have a dedicated and protected section in the memory space, which protected section corresponds to a specific section of the external display 40. Hence each mobile terminal may change only a specific part of an image shown on the external display 40.

In a further embodiment of the present invention the mobile terminal receives an application directly from the servers. The application is the executed by the processor of the mobile terminal and graphical data transmitted to the external display 40.

An application may, for example, be an automated shopping application enabling a user of the mobile terminal to utilise the external display 40 for viewing of products for sale. The shopping application may further enable the user of the mobile terminal to purchase products, register and process the user's purchase, and bill the user for the purchase using for example the mobile terminal identity IMSI.

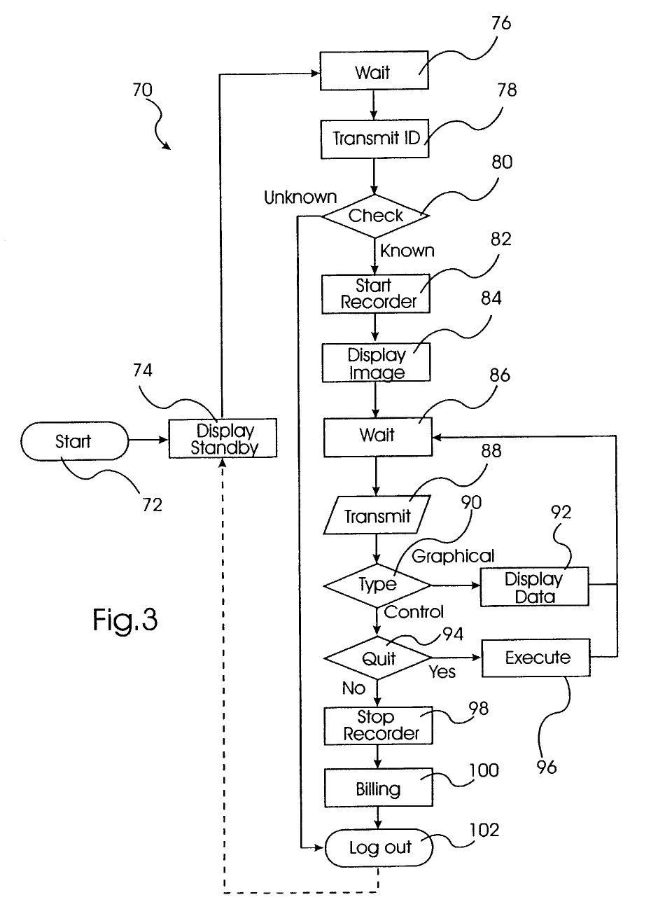

FIG. 3, shows a flow chart of a method according to a fifth embodiment of the present invention designated in entirety by reference numeral 70. The method 70 enables a mobile terminal to utilise an external screen as described with reference to FIGS. 1 and 2. The method 70 initialises during start 72, that is, performing status operations, zeroing number of connected mobile terminals, and powering up for running mode.

The method 70 preliminary sets the external display in a standby mode in state 74. During this state the external display displays a standby image. The standby image may be commercials running in the background or any relevant general information such as departure or arrival times for plains trains or busses.

The method 70 awaits for mobile terminal requests from any mobile terminal in the vicinity of the external display during a wait 76 state.

In order for a specific mobile terminal to utilise the external display the method 70 enables the mobile terminal to transmit an identifier during state 78, which identifier may be an IMST, credit identity, or user name.

The method 70 checks whether the identity is valid during check 80. If the identity is recognised during the check 80 the method 70 starts a recorder 82 for logging the time spent and/or services ordered by the requesting mobile terminal. Alternatively, if the identity is not recognised during the check 80 the method terminates the session by entering a log out state 102.

When the identity of the mobile terminal is verified and acknowledged by the method 70, then the method 70 display a ready image on the external display during a display image 84 state. The ready image may comprise any graphics such as a still image or a stream of images and audio effects.

While the external display displays the ready image, the method 70 enters a wait 86 state. During the wait 86 state the method 70 awaits instruction data from the mobile terminal determining the mobile terminal's requests for the external display.

The mobile terminal transmits the instruction data during transmit 88. When the instruction data are received by the external display the method enters a type 90 state for identifying, which type of instruction data are received. The instruction data may be either graphical data or control data as described above with reference to FIG. 2. If the instruction data are graphical data the method 70 enters a display data 92 state during which the external display displays the graphical data and subsequently returns to the wait 86 state for awaiting further instruction data. If on the other hand the instruction data are control data the method 70 enters a quit 94 state during which the method 70 determines whether the control data comprises a quit instruction from the mobile terminal.

If the method 70 determines that the control data is not a quit instruction then the method 70 enters a execute 96 state during which the method enables the external display to execute the control data and subsequently returns to the wait 86 state. If on the other hand the method 70 determines that the control data comprises a quit instruction the method 70 enters a stop recorder 98 state during which the method 70 finalises the timing and counting of data transfers by generating a price. The price is generated on the basis of the time spent communicating with the external display and/or the data transfer performed during a communication session. The price may further include purchases performed during the session.

Following the stop recorder 98 state the method 70 enters a billing 100 state during which the method 70 debits the specific mobile terminals account.

Finally, the method 70 enters a log out 102 state were the specific mobile terminal is disconnected from the external display and the method 70 return to the display standby 74.

1. A method for providing a communication session between a mobile terminal and an external display, comprising:
(a) receiving a request from said mobile terminal for establishing said communication session by means of said external display connecting to said mobile terminal through a first communications network; and
(b) receiving instruction data from said mobile terminal and executing said instruction data by means of said external display.

2. A method according to claim 1 further comprising the step of verifying identity of said mobile terminal by means of said external display so as to ensure said identity is valid before the receiving step.

3. A method according to claim 2, further comprising displaying a standby image by means of said external display until said verifying identity determines said identified is valid.

4. A method according to any of claims 1 to 3 further comprising waiting for said request from said mobile terminal by means of said external display.

5. A method according to any of claims 1 to 4 further comprising transmitting said request to said external display by means of said mobile terminal, said request comprising an identity signal.

6. A method according to any of claims 1 to 5, wherein said identity is an International Mobile Station Identifier (IMSI).

7. A method according to any of claims 1 to 6, wherein said verifying identity comprises performing a database lookup by means of said external display communicating with a server through a second communication network, said server communicating verification data to said external display.

8. A method according to claim 7 further comprising terminating said communication session in accordance with said verification data.

9. A method according to any of claims 1 to 8, wherein said verifying identity comprises initiating a session recorder recording said communication session parameters.

10. A method according to any of claims 1 to 9, wherein said communication session parameters comprise information such as log in time, log out time, and/or data transfer amount.

11. A method according to any of claims 1 to 10 further comprising displaying a ready image by means of said external display so as to inform a user of said mobile terminal that said communication session has begun.

12. A method according to any of claims 1 to 11 further comprising transmitting instruction data to said external display by means of said mobile terminal.

13. A method according to claim 12, wherein said instruction data comprise graphical data to be displayed on said external display, control data to be executed by said external display, or any combination thereof.

14. A method according to any of claims 1 to 13 further comprising billing said mobile terminal in accordance with communication session parameters by means of said external display.

15. A method according to claim 14, wherein said billing comprises terminating said session recorder recording said communication session parameters and calculating on the basis of said communication session parameter a debit of an account of said mobile terminal by means of said external display.

16. A method according to claim 15 further comprising communicating said debit to said server through said second communication network by means of said external display.

17. A method according to any of claims 1 to 16 further comprising maintaining said communication session until a quit instruction in said instruction data is identified by means of said external display.

18. An external display for providing a communication session with a requesting mobile terminal, comprising:
(a) a first I/O unit for communicating with said mobile terminal through a first communications network;
(b) a second I/O unit for communicating with a server through a second communications network;
(c) a processor unit for executing instruction data received by said first I/O unit and for presenting data received by said second I/O unit; and
(d) a display unit for displaying images driven by a first driver unit and displaying images in accordance with instructions from said processor unit.

19. An external display according to claim 18, wherein said first I/O unit comprises a wireless connection such as an infrared connection or bluetooth connection, a wired connection such as a docket station or wired connector, or any combinations thereof for connecting to said first communication network.

20. An external display according to any of claims 18 or 19, wherein said second I/O unit comprises a wired or wireless connection to a dedicated line, a local area network, wide area network, metropolitan area network, internetwork, or any combinations thereof.

21. An external display according to any of claims 18 to 20, wherein said processor unit comprises a microprocessor adapted to execute instruction data received from said mobile terminal, said instruction data being graphical data for direct display on said display or control data for direct executing by said microprocessor.

22. An external display according to any of claims 18 to 21, wherein said display comprises a size such as in the range from 6″ to 42″ or ranges 6″ to 12″, 10″ to 16″, 14″ to 26″, 24″ to 42″.

23. An external display according to any of claims 18 to 22, wherein said display comprises a series of associated display units.

24. An external display according to any of claims 18 to 23, wherein said display comprises a cathode ray tube display, liquid crystal display, a projection unit display or any combination thereof.

25. An external display according to any of claims 18 to 24, wherein said processor unit is adapted to execute instruction data from a plurality of mobile terminals concurrently.

26. An external display according to any of claims 18 to 25 further comprising a load speaker driven by a second driver receiving audio in accordance with said instruction data from said processor unit.

27. An external display according to any of claims 18 to 26, wherein said second communications network comprises connection to a plurality of servers presenting information such as movie streams, games, stock market views, Internet access, shopping facilities, or any combination thereof.

28. An external display according to any of claims 18 to 27, wherein said external display incorporates any features of said method according to claims 1 to 17.
